(19) United States
(12) Patent Application Publication
(10) Pub. No.: US 2003/0159243 A1
(43) Pub. Date: Aug. 28, 2003

(54) Doorstop for vehicles

(76) Inventor: Vittorio Audisio, Milano (IT)

Correspondence Address: TRASK BRITT, P.O. BOX 2550, SALT LAKE CITY, UT, 84110, US

(21) Appl. No.: 10/157,332

(22) Filed: May 29, 2002

(30) Foreign Application Priority Data
Feb. 22, 2002 (EP) 02425097.9

(51) Int. Cl. B60J 1/06

(52) U.S. Cl. 16/82

(57) ABSTRACT

A doorstop for vehicle doors, including:

a base structure (12) destined to be fixed to the door of a vehicle and carrying a pair of rollers (22 and 28), turning around their respective axes (24 and 30), which are mutually parallel,

elastic means (26) carried by the said base structure (12) and arranged to elastically push the said rollers (22 and 28) against each other, and

a tie rod (32), having a pair of opposed rolling surfaces (34) against which the said rollers (22 and 28) act, and arranged in a mobile manner between the said rollers,

a casing made of a plastic material (38 and 40) that encloses the assembly, including the said base structure (12), the said rollers (22 and 28) and the said elastic means (26), the said casing (38 and 40) being equipped with at least one opening (54 and 56) through which the tie rod (32) passes.

The present invention relates to doorstop for vehicle doors as described in the preamble of the main claim.

For many years, the applicant has successfully produced a doorstop for vehicles, comprising a bent sheet metal structure carrying a first roller, rotating around a fixed axis, and an elastic element composed of a shaped metal rod that carries a second roller on one end that is elastically pushed against the first roller. The two rollers act against the opposed rolling surfaces of a tie rod equipped with positioning notches that define respective stable stop positions, corresponding to one or more partially open door positions and a fully open door position, for example.

One of the main problems of this type of doorstop is that of noise during door opening and closing manoeuvres. Lubricating greases are often used in devices of this type to reduce the noise of the rollers turning around their respective axes. However, the use of lubricants constitutes a problem for the operators that manually carry out the mounting of doorstops on vehicles because, in observance of hygiene and safety at work regulations, direct skin contact with potentially dangerous components contained in the lubricants must be avoided. A further problem is represented by the fact that, during use, dust and humidity can compromise the efficiency of the lubricant and compromise, at least in part, the smooth turning of the rollers around their axes.

The object of the present invention is to provide an improved doorstop that overcomes the aforementioned drawbacks.

In accordance with the invention, this object is achieved by a doorstop having the characteristics that form the subject matter of the main claim.

Characteristics and advantages of the invention will be become evident in the course of the detailed description that follows, provided purely as a non limitative example and wherein:

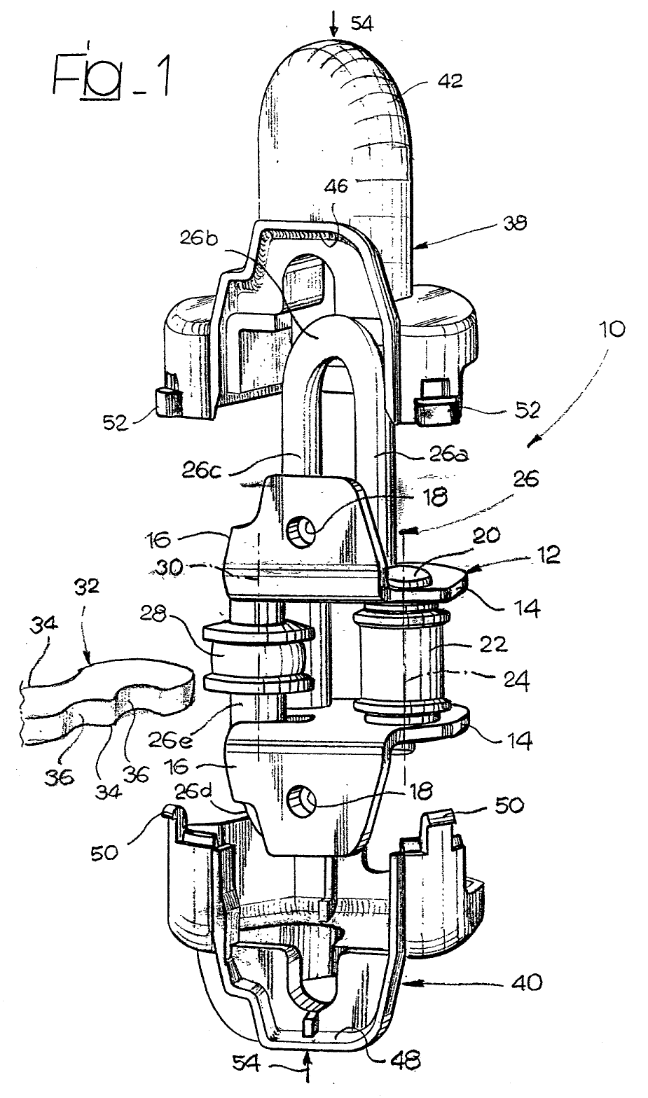

FIG. 1 is an exploded perspective view of a doorstop in accordance with the invention,

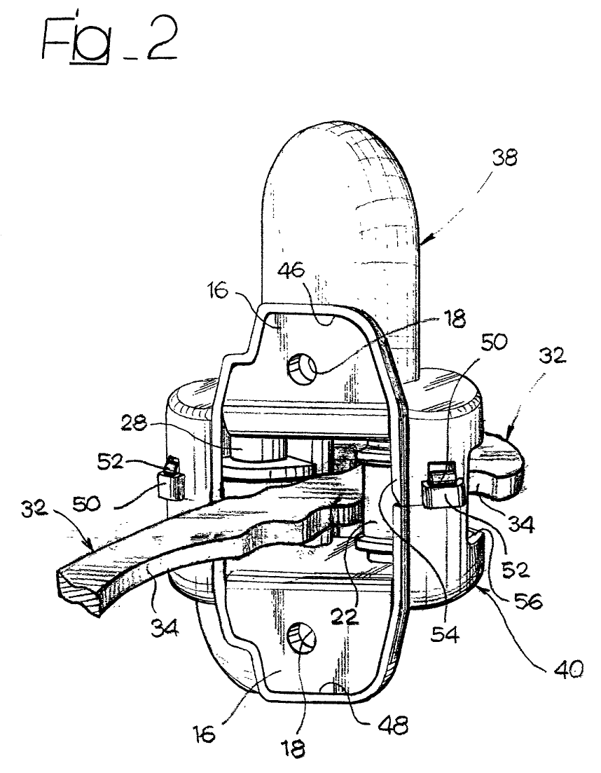

FIG. 2 is a perspective view of the doorstop of FIG. 1 when assembled,

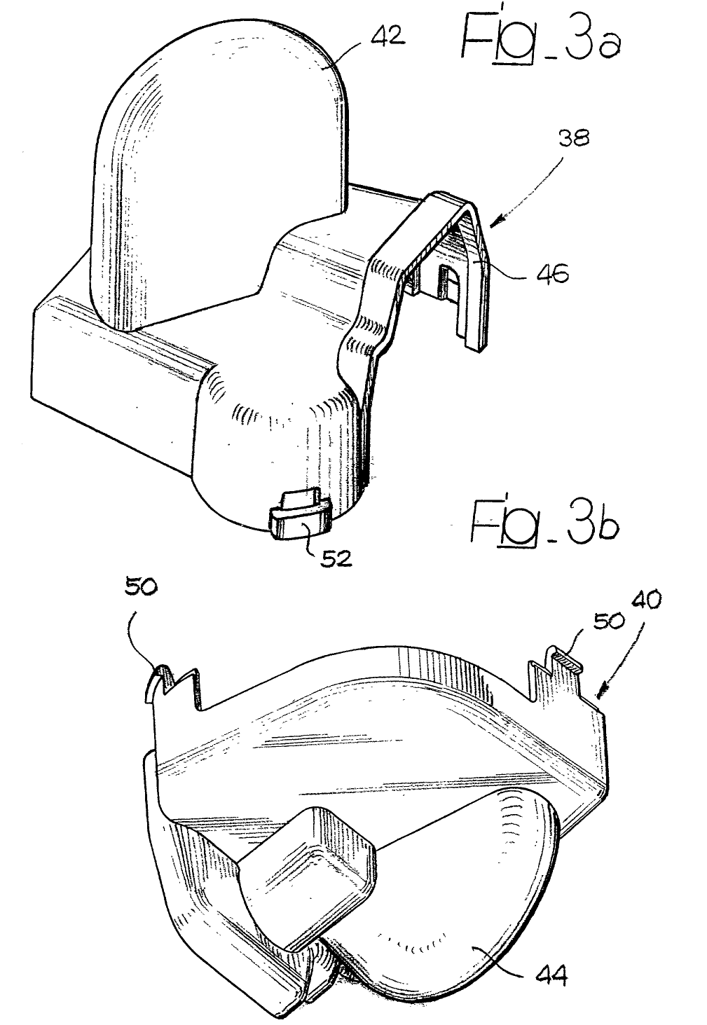

FIGS. 3a and 3b are perspective views illustrating two shells forming a protective casing for the doorstop in accordance with the invention, and

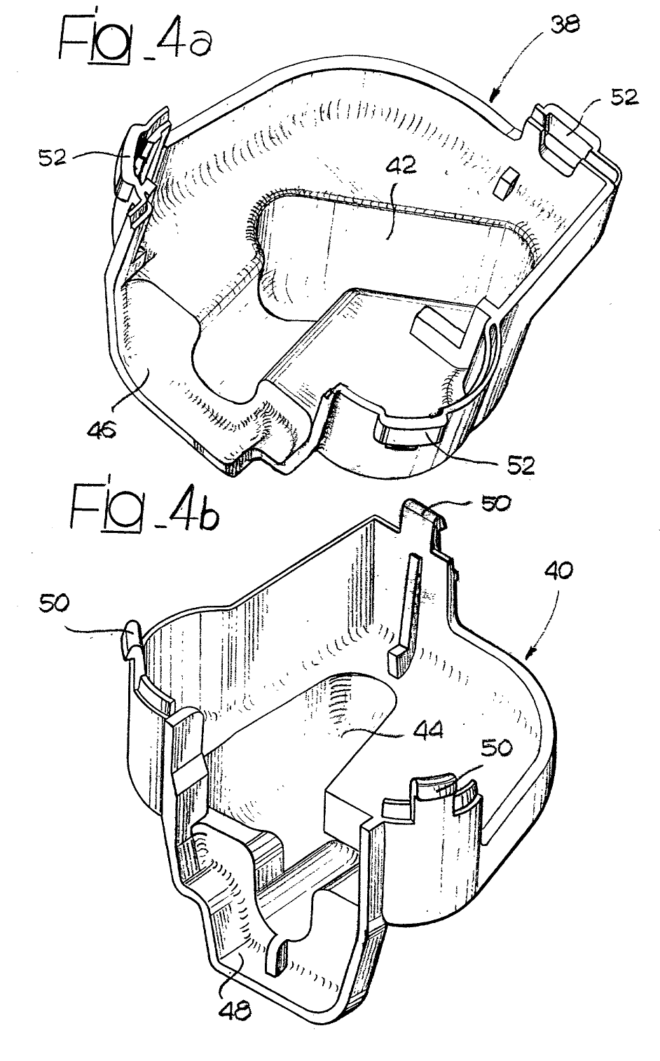

FIGS. 4a and 4b are perspective views illustrating the two shells of FIGS. 3a and 3b from a different viewpoint.

With initial reference to FIG. 1, item 10 indicates a doorstop in accordance with the invention. The device 10 comprises a base structure 12 of bent sheet metal including two parallel walls 14, each of which has a portion bent at approximately 90° to form a flange 16, equipped with a hole 18 for mounting the device 10 to the door of a vehicle (not illustrated). The ends of a pivot pin 20, on which a first roller 22 can freely rotate around its own axis, indicated as 24, are fixed to the parallel walls 14. The base structure 12 carries an elastic element 26 consisting of a metal bar of circular cross-section and an essentially “S” shaped form, with a first linear section 26a, an upper arched section 26b, a second linear section 26c, a lower arched section 26d (only partially visible in FIG. 1) and a third linear section 26e. A freely rotating second roller 28 is mounted on this last linear section, turning around its own axis 30, parallel to the axis 24 of the first roller 22. The two linear sections 26a and 26c are anchored to the base structure 12 in a known manner. The elastic element 26 produces an elastic force that tends to push the two rollers 22 and 28 together. A metal tie rod 32 is inserted between the two rollers 22 and 28. The metal tie rod 32 has two opposed rolling surfaces 34 against which the two rollers 22 and 28 are pressed by the force exerted by the elastic element 26. One end of the tie rod 32, not shown in the drawings, is articulated to an upright of a vehicle and at least one of the rolling surfaces 34 is equipped with a series of positioning notches 36 that are engaged by one or both of the rollers 26 and 28 to define the door's stable stop positions. Usually, the contact zone between at least one of the rollers 22 and 28 and the respective pivot pin 20 or 26e is lubricated using a solid lubricant, typically a grease, to favour rotation of the rollers during motion of the tie rod.

The doorstop 10 described up until now is current technology and its operation is well known to a technical expert in this field. The invention provides a protective casing that envelopes the assembly, including the base structure 12, elastic element 26 and the rollers 22 and 28. In the form of embodiment illustrated in the figures, the protective casing is formed by two shells 38 and 40 made of a plastic material, via injections moulding for example. As illustrated in FIGS. 3a, 3b and 4a, 4b, each of the two shells 38 and 40 has an internal surface which mates with the outline of the respective upper or lower half of the doorstop. In particular, the two shells 38 and 40 possess respective seats 42 and 44 for receiving the respective arched portions 26b and 26d of the elastic element 26. Each shell 38 and 40 also has reference surfaces 46 and 48 that match the external profile of the base structure 12 and, in particular, the flange 16 of the latter. The shells 38 and 40 are equipped with mutually cooperating snap-fit means of coupling, including a series of teeth 50 formed on one of the shells and destined to engage with corresponding snap-fit seats 52 formed on the other shell, such that the two shells 38 and 40 become firmly fixed together and to the doorstop 10 following the reciprocal coupling between the teeth 50 and the seats 52. This coupling is obtained by simply bringing the shells 38 and 40 together in a direction parallel to the axes of the rollers 22 and 21, as indicated by arrow 54 in FIG. 1.

As shown in FIG. 2, in the assembled condition, the two shells 38 and 40 form a pair of openings 54 and 56 that allow the tie rod 32 to freely move between the rollers 22 and 28 in the direction of its longitudinal axis. The opening 54 also surrounds the flange 16, leaving the frontal contact surface of the flange free for mounting on the vehicle door.

The casing formed by the shells 38 and 40 constitutes a protection that reduces infiltration of water, dust and other external agents in the zone of relative movement between the tie rod 32 and the rollers 22 and 28. This casing also has the function of reducing the noise of the doorstop. Another useful function of the casing is that of preventing the operators who mount the doorstop on the vehicles from coming into contact with the lubricant used for lubricating the rollers.

1. A doorstop for vehicles, including:
a base structure destined to be fixed to the door of a vehicle and carrying a pair of rollers and , turning around their respective axes, which are mutually parallel,
elastic means carried by the said base structure and arranged to elastically push the said rollers against each other,
a tie rod, having a pair of opposed rolling surfaces against which the said rollers act, and arranged in a mobile manner between the said rollers, and
a casing made of a plastic material that encloses the assembly, including the said base structure , the said rollers and the said elastic means, the said casing being equipped with at least one opening through which the tie rod passes.

2. A device according to claim 1, wherein said casing includes a pair of shells equipped with mutually cooperating snap-fit couplings.

3. A device according to claim 2, wherein said shells are equipped with reference surfaces cooperating with at least part of the external profile of the said base structure.

4. A device according to claim 2, wherein said shells are equipped with respective seats that receive the respective arched portions of an elastic element formed by a metal rod with an overall “S” shaped form.
